(19) United States
(12) Patent Application Publication
(10) Pub. No.: US 2004/0255207 A1
(43) Pub. Date: Dec. 16, 2004

(54) Microcomputer

(76) Inventors: Kazuhiro Ika, Takatsuki-shi (JP); Tamaki Iwasaki, Kadoma-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/835,070

(22) Filed: Apr. 30, 2004

(30) Foreign Application Priority Data
Apr. 30, 2003 (JP) 2003-125739

(51) Int. Cl. H02H 3/05

(52) U.S. Cl. 714/55

(57) ABSTRACT

A microcomputer including a runaway detection control unit for monitoring a communication between external processing units that are provided outside the microcomputer, and a memory access control unit. When detecting that the communication between an external processing unit and the CPU gets into a runaway state while the CPU is performing a memory access to the external processing unit in a handshaking method, the runaway detection control unit outputs a pseudo acknowledge signal to the memory access control unit, in place of the normal acknowledge signal. When receiving the pseudo acknowledge signal via the memory access control unit, the CPU switches the memory access method for the external processing unit to the fixed waiting mode.

### FIELD OF THE INVENTION

The present invention relates to microcomputers and, more particularly, to microcomputers that detect a runaway state of a communication between a central processing unit and an external processing unit that has a memory function when the central processing unit performs a memory access to the external processing unit in a handshaking mode, thereby avoiding a runaway of the central processing unit.

### BACKGROUND OF THE INVENTION

A conventional microcomputer will be described with reference to FIG. 13 (for example, referred to Japanese Published Patent Application No. Hei.04-217035). FIG. 13 is a diagram schematically illustrating a principal part of the conventional microcomputer. In FIG. 13, a microcomputer 1 includes a central processing unit (hereinafter, referred to as a CPU) 10 and a memory access control unit 11. Processing units A13, B14, C15, and D16 having a memory function, respectively, are provided outside the microcomputer 1. The CPU 10 and the memory access control unit 11 are connected to each other through an address signal AD, a data signal DT, an acknowledge signal DK, a chip select signal CS0 for the processing unit A, a chip select signal CS1 for the processing unit B, a chip select signal CS2 for the processing unit C, and a chip select signal CS3 for the processing unit D.

In addition, the memory access control unit 11 and the processing unit A13 are connected to each other through an address signal A0 for the processing unit A, a data signal D0 for the processing unit A, a chip select signal CS0 for the processing unit A, and an acknowledge signal DK0 for the processing unit A. Further, the memory access control unit 11 and the processing unit B14 are connected to each other through an address signal A1 for the processing unit B, a data signal D1 for the processing unit B, a chip select signal CS1 for the processing unit B, and an acknowledge signal DK1 for the processing unit B.

The memory access control unit 11 and the processing unit C15 are connected to each other through an address signal A2 for the processing unit C, a data signal D2 for the processing unit C, and a chip select signal CS2 for the processing unit C, and the memory access control unit 11 and the processing unit D16 are connected to each other through an address signal A3 for the processing unit D, a data signal D3 for the processing unit D, and a chip select signal CS3 for the processing unit D.

In FIG. 13, a memory access by the CPU 10 to the processing unit A13 or B14 is executed in a handshaking mode. In the handshaking mode, after a memory access is started, the memory access is finished by sending an acknowledge signal from the processing unit back to the CPU 10 via the memory access control unit 11. On the other hand, a memory access by the CPU 10 to the processing unit C15 or D16 is executed in a fixed waiting mode. In the fixed waiting mode, a memory access is executed in a set waiting cycle from the start to the end.

Further, in FIG. 13, the memory accesses by the CPU 10 to the processing units A13, B14, C15 and D16 are exclusively controlled by the CPU 10. That is, unless a memory access to one processing unit is finished, the CPU 10 cannot execute a memory access to the next processing unit.

The operation of the conventional microcomputer 1 that is constructed as described above will be described. Initially, a description is given of a memory access by the CPU 10 to the processing unit A13. When performing a memory access to the processing unit A13 in the handshaking mode to extract information which is stored in the processing unit A13, the CPU 10 outputs a chip select signal CS0 for the processing unit A and an address signal AD indicating an address value to be accessed, to the memory access control unit 11, thereby requesting the memory access to the processing unit A13. When receiving these signals, the memory access control unit 11 outputs the chip select signal CS0 for the processing unit A and an address signal A0 for the processing unit A, to the processing unit A13. At this point of time, the memory access to the processing unit A13 is started. When a series of processings for the processing unit A13 are finished, the processing unit A13 sends an acknowledge signal DK back to the CPU 10 via the memory access control unit 11. Then, the memory access control unit 11 negates the chip select signal CS0 for the processing unit A, whereby the memory access is finished.

Similarly, the CPU 10 executes a memory access to the processing unit B14 in the handshaking mode to read information which is stored in the processing unit B14.

Next, a memory access by the CPU 10 to the processing unit 15C is described. When performing a memory access to the processing unit C15 in the fixed waiting mode to extract information which is stored in the processing unit C15, the CPU 10 outputs a chip select signal CS2 for the processing unit C and an address signal AD indicating an address value to be accessed, to the memory access control unit 11, thereby requesting the memory access to the processing unit C15. When receiving these signals, the memory access control unit 11 outputs the chip select signal CS2 for the processing unit C and an address signal A2 for the processing unit C to the processing unit C15. At this point of time, the memory access to the processing unit C15 is started. When a series of processings to the processing unit C15 in the set waiting cycle are completed, the memory access control unit 11 negates the chip select signal CS2 for the processing unit C, whereby the memory access is finished.

Similarly, the CPU 10 performs a memory access to the processing D16 in the fixed waiting mode, thereby extracting information that is stored in the processing unit D16.

In the above-mentioned conventional microcomputer, when the CPU performs a memory access to an external processing unit having a memory function in the handshaking mode and when this memory access needs a large amount of processing, the external processing unit may be occupied by this memory access processing and the acknowledge signal would not be sent back to the CPU. When the acknowledge signal is not sent back to the CPU, the memory access is not finished, and accordingly the processing unit cannot accept even a memory access interrupt instruction from the CPU. Consequently, the memory accesses would be stagnated, finally resulting in a runaway of the CPU.

### SUMMARY OF THE INVENTION

The present invention has for its object to provide a microcomputer that detects a runaway state of a communication between a CPU and an external processing unit having a memory function when the CPU executes a memory access with a large amount of processing to the external processing unit, thereby avoiding a runaway of the CPU.

Other objects and advantages of the invention will become apparent from the detailed description that follows. The detailed description and specific embodiments described are provided only for illustration since various additions and modifications within the spirit and scope of the invention will be apparent to those of skill in the art from the detailed description.

According to a 1st aspect of the present invention, there is provided a microcomputer comprising a central processing unit and a memory access control unit that performs a control when the central processing unit makes a memory access to an external processing unit having a memory function, including a runaway detection control unit comprising: a watching dog timer including a counter, for counting a time using the counter and generating a pulse signal when a predetermined time is counted; a runaway detection circuit for detecting that a memory access from the central processing unit to the external processing unit has not been normally finished and outputting a runaway detection signal; a signal generation unit for generating a pseudo acknowledge signal indicating that the memory access from the central processing unit to the external processing unit has been finished, on the basis of the runaway detection signal, and outputting the generated acknowledge signal to the central processing unit; and the runaway detection circuit outputting the runaway detection signal when the watching dog timer generates the pulse signal during a period from which a memory access from the central processing unit to the external processing unit is started to when the memory access is finished. Therefore, even when a communication between the central processing unit and an external processing unit has gotten into a runaway state, it is possible to prevent a runaway of the central processing unit, thereby avoiding stoppage of the system.

According to a 2nd aspect of the present invention, in the microcomputer according to the 1st aspect, the central processing unit exclusively performs a memory access to a plurality of the external processing units, and the runaway detection control unit detects an external processing unit, the memory access to which from the central processing unit has not been normally finished. Therefore, even when a communication between the central processing unit and an external processing unit has gotten into runaway, it is possible to halt the memory access to the external processing unit in the runaway state, thereby preventing the central processing unit from getting into runaway and avoiding stoppage of the system.

According to a 3rd aspect of the present invention, in the microcomputer according to the 1st aspect, when the runaway detection control unit detects that the memory access from the central processing unit to the external processing unit has not been normally finished, the central processing unit switches a memory access method for the external processing unit from a handshaking mode to a fixed waiting mode. Therefore, even when a communication between the central processing unit and an external processing unit has gotten into runaway, it is possible to get the memory access into a finished state, thereby preventing the central processing unit from getting into runaway and avoiding stoppage of the system.

According to a 4th aspect of the present invention, in the microcomputer according to the 2nd aspect, the runaway detection control unit includes a reset circuit for initializing the runaway detection circuit which has detected that the memory access from the central processing unit to the external processing unit has not been normally finished, and freeing a memory space of the external processing unit, the memory access to which from the central processing unit has not been normally finished. Therefore, it is possible to free a memory space of an external processing unit, the communication of which with the central processing unit has gotten into a runaway state, thereby making a standby state for the next access.

According to a 5th aspect of the present invention, there is provided a microcomputer comprising a central processing unit and a memory access control unit that performs a control when the central processing unit makes a memory access to an external processing unit having a memory function, including a runaway detection control unit comprising: a watching dog timer including a counter, for counting a time using the counter and generating a pulse signal when a predetermined time is counted; a runaway detection circuit for detecting that a memory access from the central processing unit to the external processing unit has not been normally finished and outputting a runaway detection signal; and the runaway detection circuit outputting the runaway detection signal to an interrupt processing unit of the central processing unit when the watching dog timer generates the pulse signal during a period from when the memory access from the central processing unit to the external processing unit is started to which the memory access is finished, and the interrupt processing unit limiting the memory access to the external processing unit when receiving the runaway detection signal. Therefore, even when a communication between the central processing unit and an external processing unit has gotten into runaway, it is possible to prevent the central processing unit from getting into runaway and avoiding stoppage of the system.

According to a 6th aspect of the present invention, there is provided a microcomputer comprising a central processing unit and a memory access control unit that performs a control when the central processing unit exclusively makes a memory access to a plurality of external processing units each having a memory function, including: a runaway informing unit for receiving a runaway notification from an external processing unit, the memory access to which from the central processing unit has not been normally finish and has gotten into a runaway state, and providing the central processing unit with information of the external processing unit that has gotten into the runaway state via an external processing unit that is different from the external processing unit that has gotten into the runaway state and the memory access control unit. Therefore, even when a communication between the central processing unit and an external processing unit has gotten into runaway, it is possible to halt the memory access to the external processing in the runaway state, thereby preventing the central processing unit from getting into runaway and avoiding stoppage of the system.

According to a 7th aspect of the present invention, there is provided a microcomputer comprising a central processing unit and a memory access control unit that performs a control when the central processing unit makes a memory access to an external processing unit having a memory function, including a runaway avoidance control unit comprising: a watching dog timer including a counter, for counting a time using the counter and generating a pulse signal when a predetermined time is counted; a signal generation unit for generating a pseudo acknowledge signal indicating that a memory access from the central processing unit to the external processing unit has been finished, on the basis of the pulse signal; and the signal generation unit outputting the pseudo acknowledge signal to the central processing unit when the watching dog timer has counted the predetermined time after the memory access was started. Therefore, even when a communication between the central processing unit and an external processing unit has gotten into runaway, it is possible to halt the access to the external processing unit in the runaway state, thereby preventing the central processing unit from getting into runaway and avoiding stoppage of the system.

### BRIEF DESCRIPTION OF THE DRAWINGS

FIG. 1 is a block diagram illustrating a microcomputer according to a first embodiment of the present invention.

FIG. 2 is a diagram illustrating a detailed structure of a runaway detection control unit of the microcomputer according to the first embodiment.

FIG. 3 is a timing chart for explaining an operation of the runaway detection control unit of the microcomputer according to the first embodiment.

FIG. 4 is a block diagram illustrating a microcomputer according to a second embodiment of the present invention.

FIG. 5 is a timing chart for explaining an operation of a runaway detection control unit of the microcomputer according to the second embodiment.

FIG. 6 is a block diagram illustrating a microcomputer according to a third embodiment of the present invention.

FIG. 7 is a timing chart for explaining an operation of a runaway detection control unit of the microcomputer according to the third embodiment.

FIG. 8 is a block diagram illustrating a microcomputer according to a fourth embodiment of the present invention.

FIG. 9 is a block diagram illustrating a microcomputer according to a fifth embodiment of the present invention.

FIG. 10 is a block diagram illustrating a microcomputer according to a sixth embodiment of the present invention.

FIG. 11 is a diagram illustrating a detailed structure of a runaway avoidance control unit of the microcomputer according to the sixth embodiment.

FIG. 12 is a timing chart for explaining an operation of the runaway avoidance control unit of the microcomputer according to the sixth embodiment.

FIG. 13 is a block diagram illustrating a conventional microcomputer.

### DETAILED DESCRIPTION OF THE PREFERRED EMBODIMENTS

Hereinafter, microcomputers according to embodiments of the present invention will be described with reference to the drawings.

[Embodiment 1]

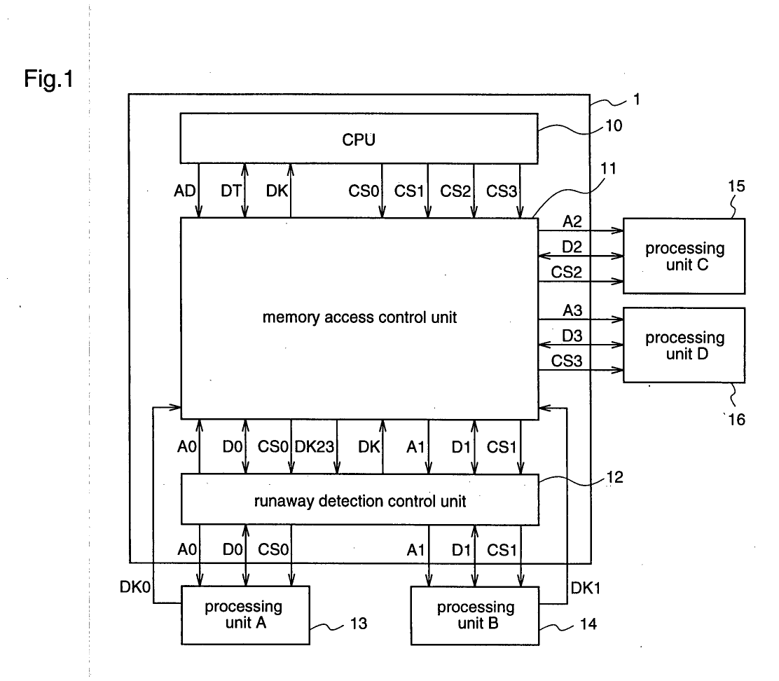

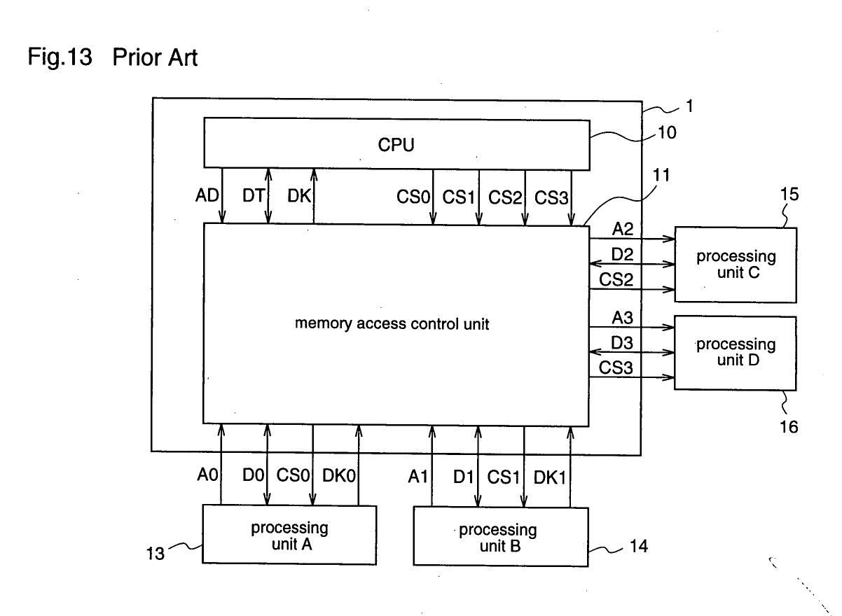

FIG. 1 is a block diagram illustrating a structure of a microcomputer according to a first embodiment of the present invention. In FIG. 1, the same reference numerals as those in FIG. 13 denote the same or corresponding components. The microcomputer according to the first embodiment is characterized by a runaway detection control unit 12. The runaway detection control unit 12 detects a runaway state of a communication between a CPU 10 and a processing unit A13 or B14.

In FIG. 1, the runaway detection control unit 12 and a memory access control unit 11 are connected to each other through an address signal A0 for the processing unit A, a data signal D0 for the processing unit A, a chip select signal CS0 for the processing unit A, an acknowledge signal DK23 for the processing units A and B, an acknowledge signal DK, an address signal A1 for the processing unit B, a data signal D1 for the processing unit B, and a chip select signal CS1 for the processing unit B.

The runaway detection unit 12 and the processing unit A13 are connected to each other through the address signal A0 for the processing unit A, the data signal D0 for the processing unit A, and the chip select signal CS0 for the processing unit A. The runaway detection unit 12 and the processing unit B14 are connected to each other through the address signal A1 for the processing unit B, the data signal D1 for the processing unit B, and the chip select signal CS1 for the processing unit B.

Further, the processing unit A13 and the memory access control unit 11 are connected to each other through an acknowledge signal DK0 for the processing unit A, and the processing unit B14 and the memory access control unit 11 are connected to each other through an acknowledge signal DK1 for the processing unit B.

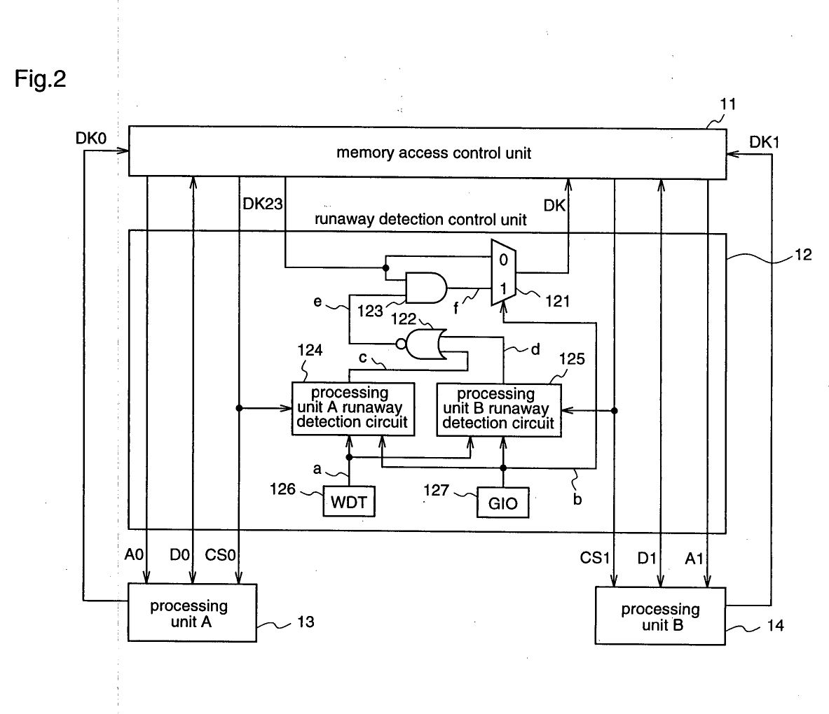

Hereinafter, the runaway detection control unit 12 will be described in more detail with reference to FIG. 2. FIG. 2 is a block diagram illustrating a structure of the runaway detection control unit 12. In FIG. 2, the same reference numerals as those in FIGS. 1 and 13 denote the same or corresponding components. The runaway detection control unit 12 includes a selector 121, a NOR circuit 122, an AND circuit 123, a processing unit A runaway detection circuit 124, a processing unit B runaway detection circuit 125, a watching dog timer (hereinafter, referred to as a WDT) 126, and a general-purpose I/O port (hereinafter, referred to as a GIO) 127.

The WDT 126 having an internal counter asserts an overflow signal “a” when a count value of the internal counter becomes a set value. The GIO 127 outputs a signal “b” indicating whether the runaway detection control unit 12 is to be switched ON or not. The processing unit A runaway detection circuit 124 detects whether or not the processing unit A13 has gotten out of control, and outputs a runaway signal “c” for the processing unit A. The processing unit B runaway detection circuit 125 detects whether or not the processing unit B14 has gotten out of control, and outputs a runaway signal “d” for the processing unit B. The NOR circuit 122 generates a runaway detection signal “e” indicating that the processing unit A13 or B14 has gotten out of control, from the runaway signal c for the processing unit A and the runaway signal d for the processing unit B. The AND circuit 123 generates a pseudo acknowledge signal “f” from the normal acknowledge signal DK23 and the runaway detection signal e. The selector 121 selects one of the normal acknowledge signal DK23 from the memory access control unit 11 and the pseudo acknowledge signal f, and outputs the selected signal as the acknowledge signal DK to the memory access control unit 11.

The microcomputer that is constructed as described above according to the first embodiment performs a memory access from the CPU 10 to the processing unit A13 or B14 in the handshaking mode while performing a memory access from the CPU 10 to the processing unit C15 or D16 in the fixed waiting mode, as the conventional microcomputer. Further, the respective memory accesses from the CPU 10 to the processing units A13, B14, C15 and D16 are exclusively controlled by the CPU 10.

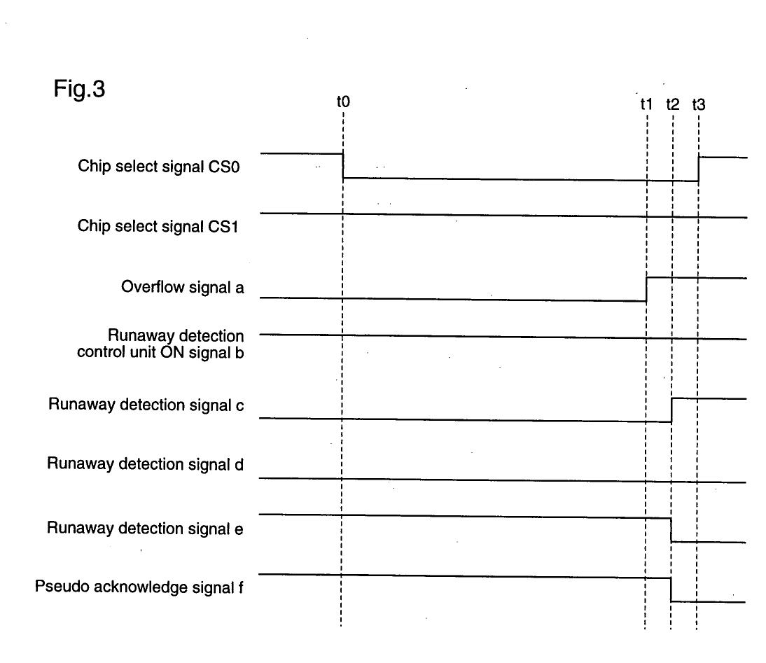

Hereinafter, the operation of the microcomputer according to the first embodiment will be described. As the memory access from the CPU 10 to the processing unit C15 or D16 is performed in the same manner as the prior art, only the memory access from the CPU 10 to the processing unit A13 or B14 is described with reference to FIG. 3.

FIG. 3 is a timing chart for explaining the operation of the microcomputer according to the first embodiment. This figure shows a case where the CPU 10 performs a memory access to the processing unit A13. In FIG. 3, t0 shows a starting time of a memory access from the CPU 10 to the processing unit A13, i.e., a time when the chip select signal CS0 for the processing unit A is asserted, t1 shows a time when the overflow signal a is asserted, t2 shows a time when the pseudo acknowledge signal f is asserted, and t3 shows a time when the memory access from the CPU 10 to the processing unit A13 is finished.

Initially, an operation of the microcomputer when the CPU 10 performs a memory access to the processing unit A13 is described. When performing a memory access to the processing unit A13, the CPU 10 outputs a chip select signal CS0 for the processing unit A and an address signal AD indicating an address value to be accessed, to the memory access control unit 11 at time t0, thereby requesting the access to the processing unit A13. It is assumed here that, at the time of memory access, the runaway detection control unit 12 is always ON in accordance with an output signal b from the GIO 127. When receiving the chip select signal CS0 for the processing unit A and the address signal AD, the memory access control unit 11 passes the chip select signal CS0 for the processing unit A and an address signal A0 for the processing unit A to the processing unit A13 via the runaway detection control unit 12. At this time, the memory access to the processing unit A13 is started.

When the memory access is started, the processing unit A runaway detection circuit 124 monitors the chip select signal CS0 and the overflow signal a from the WDT 126, and detects whether the processing unit A13 is in a runaway state or not. The WDT 126 starts counting at power-on of the system, and asserts the overflow signal a after a time period that is sufficiently longer than the normal memory access time, i.e., at a timing t1 in FIG. 3. When detecting that the overflow signal a has been asserted before the memory access is finished, i.e., before the chip select signal CS0 for the processing unit A is negated, the processing unit A runaway detection circuit 124 judges that the processing unit A13 has gotten out of control, and asserts the runaway detection signal c in the cycle t2 following the timing t1. Here, one cycle corresponds to one period of the system clock.

Next, the NOR circuit 122 receives the runaway detection signal c indicating the runaway state of the processing unit A13, and outputs the runaway detection signal e that has been asserted in timing t2. The AND circuit 123 asserts a pseudo acknowledge signal f in timing t2 on the basis of the runaway detection signal e, and outputs the asserted pseudo acknowledge signal f to the selector 121. The selector 121 selects the pseudo acknowledge signal f in accordance with the signal b as a selector signal during a period while the runaway detection control unit 12 is indicating the ON state, and outputs the selected signal to the memory access control unit 11. The memory access control unit 11 outputs the pseudo acknowledge signal f to the CPU 10, and negates the chip select signal CS0 for the processing unit A13 in the next cycle t3. Thereby, the memory access from the CPU 10 to the processing unit A13 is finished. When recognizing that the memory access to the processing unit A13 has been finished, the CPU 10 automatically switches the memory access method for the processing unit A13 from the handshaking mode to the fixed waiting mode.

When the CPU 10 performs a memory access to the processing unit B14, the processing unit B runaway detection circuit 125 detects a runaway of the processing unit B14 on the basis of a chip select signal CS1 for the processing unit B and an overflow signal a in the above-mentioned manner. When the processing unit B runaway detection circuit 125 asserts a runaway detection signal d, the NOR circuit 122 outputs a runaway detection signal e that has been asserted in the same timing as the runaway detection signal d, and the AND circuit 123 outputs a pseudo acknowledge signal f that has been asserted in the same timing as the runaway detection signal e. Following processes are the same as those at the memory access from the CPU 10 to the processing unit A13.

In this way, the runaway detection control unit 12 detects a runaway state of the communication between the CPU 10 and the processing unit A13 by the processing unit A runaway detection circuit 124, and detects a runaway state of the communication between the CPU 10 and the processing unit B14 by the processing unit B runaway detection circuit 125, thereby identifying whether the runaway occurs in the processing unit A13 or the processing unit B14.

As described above, the microcomputer according to the first embodiment includes the runaway detection control unit 12 that monitors a communication between an external processing unit having a memory function (the processing unit A13 or B14), which is provided outside the microcomputer 1, and the memory access control unit 11. When detecting that the communication between the CPU 10 and the external processing unit is in a runaway state while the CPU 10 is performing a memory access to the external processing unit in the handshaking method, the runaway detection control unit 12 sends a pseudo acknowledge signal DK in place of the normal acknowledge signal DK23 back to the CPU 10 via the memory access control unit 11. Then, the CPU 10 recognizes that the memory access has been finished on the basis of the pseudo acknowledge signal DK, and switches the memory access method for the external processing unit from the handshaking mode to the fixed waiting mode. Thereby, even when a memory access of a large amount of processing is performed and then the communication between the CPU 10 and the external processing unit has gotten out of control, this memory access is forcefully finished, thereby preventing the CPU 10 from getting out of control and thus avoiding stopping the system.

[Embodiment 2]

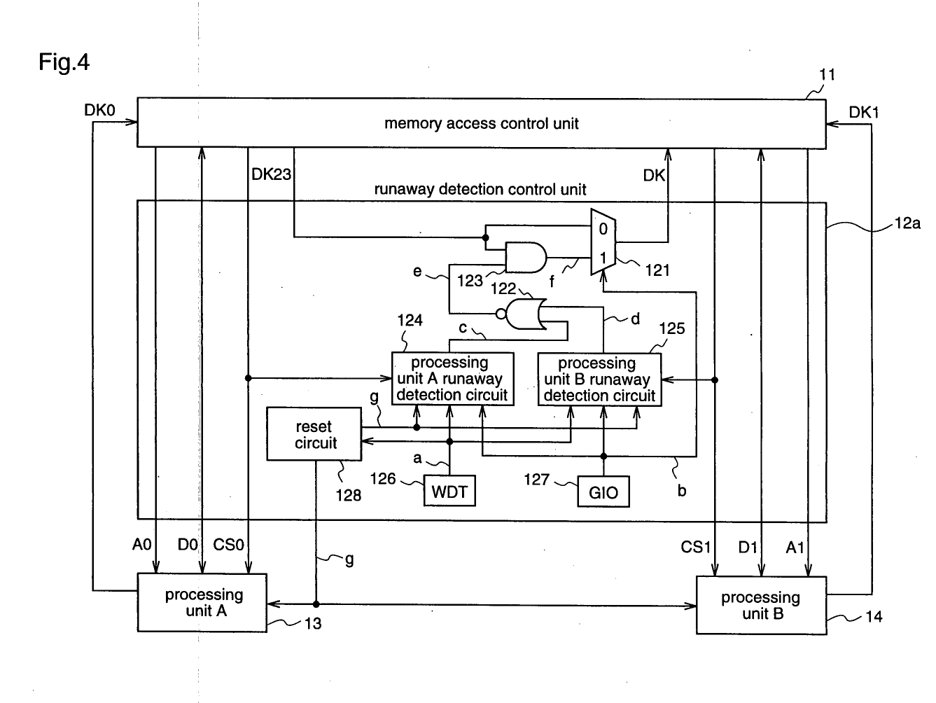

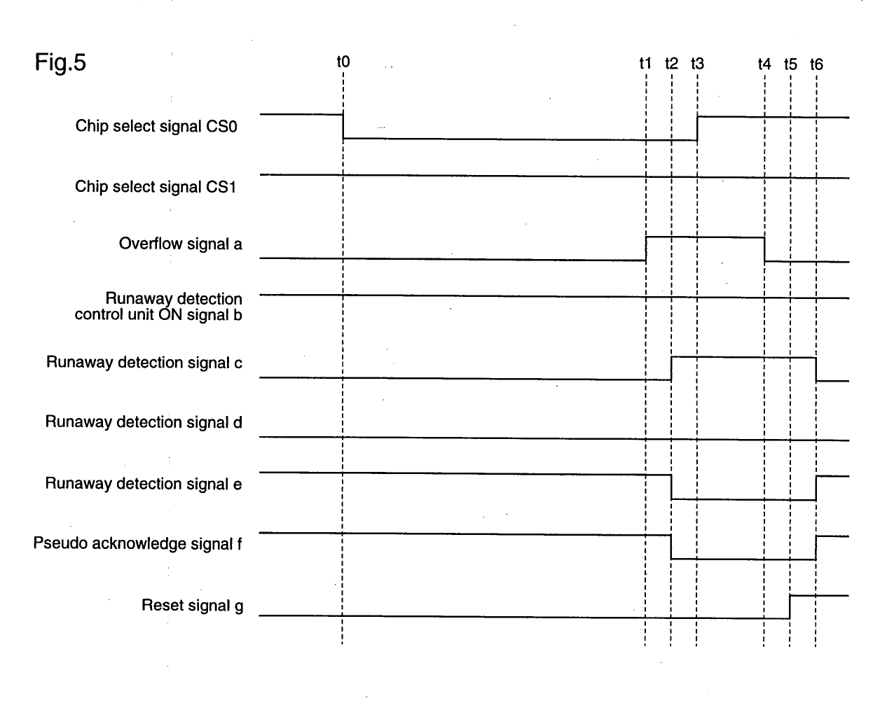

A microcomputer according to a second embodiment of the present invention will be described with reference to FIGS. 4 and 5.

FIG. 4 is a diagram illustrating a structure of a runaway detection control unit 12a of a microcomputer 1 according to the second embodiment. In FIG. 4, the same reference numerals as those in FIG. 1, 2 and 13 denotes the same or corresponding components. The runaway detection control unit 12a is characterized by a reset circuit 128. The reset circuit 128 outputs a reset signal “g” to the processing unit A runaway detection circuit 124 and the processing unit B runaway detection circuit 125 in accordance with the overflow signal a from the WDT 126, thereby to initialize these runaway detection circuits, as well as outputs the reset signal g to the processing unit A13 and the processing unit B14, thereby to free the memory spaces of the processing units.

The operation of the microcomputer that is constructed as described above will be described with reference to FIG. 5. FIG. 5 is a timing chart for explaining an operation of the microcomputer according to the second embodiment. This figure shows a case where the CPU 10 performs a memory access to the processing unit A13. In FIG. 5, t4 shows a time when an overflow signal a from the WDT 126 is negated, t5 shows a time when a reset signal g that is outputted from the reset circuit 128 to the processing unit A13, the processing unit B14, the processing unit A runaway detection circuit 124, and the processing unit B runaway detection circuit 125 is asserted, and t6 shows a time when the processing unit A runaway detection circuit 124 and the processing unit B runaway detection circuit 125 are initialized as well as a time when the memory spaces of the processing units A13 and B14 are freed.

Hereinafter, the operation in the case where the CPU 10 performs a memory access to the processing unit A13 will be described. It is assumed here that the runaway detection control unit 12a is ON in accordance with an output signal b from the GIO 127. The processes from time t0 to time t3 are the same as those in the first embodiment.

After asserting the overflow signal a, the WDT 126 negates the overflow signal a at time t4 when a count value of the internal counter reaches a set value. When the overflow signal a is negated, the reset circuit 128a asserts a reset signal g in the next cycle t5, and outputs the asserted reset signal g to the processing unit A13, the processing unit B14, the processing unit A runaway detection circuit 124, and the processing unit B runaway detection circuit 125.

Then, in the next cycle t6, the processing unit A runaway detection circuit 124 and the processing unit B runaway detection circuit 125 are initialized, thereby freeing the memory spaces of the processing units A13 and B14.

As described above, according to the microcomputer of the second embodiment, when a communication between the CPU 10 and the external processing unit (the processing unit A13 or B14) gets into a runaway state, the memory access control unit 11 outputs a pseudo acknowledge signal f to the CPU 10, thereby finishing the memory access by the CPU 10 to the external processing unit. When the count value of the internal counter of the WDT 126 reaches the set value after the memory access has been finished, the reset circuit 128 outputs a reset signal g to the external processing unit (the processing unit A13 or B14) and the runaway detection circuit (the processing unit A runaway detection circuit 124 or the processing unit B runaway detection circuit 125) to free the memory space of the external processing unit, thereby initializing the runaway detection circuit. Accordingly, even when the communication between the CPU 10 and the external processing unit gets into a runaway state, it is possible to forcefully finish the memory access to prevent the CPU from getting into a runaway state and thus avoiding stopping the system. Further, it is possible to initialize the runaway detection circuit and free the memory space of the external processing unit, the communication of which with the CPU 10 has gotten into a runaway state, in accordance with the reset signal g, thereby making a standby status for the next memory access.

[Embodiment 3]

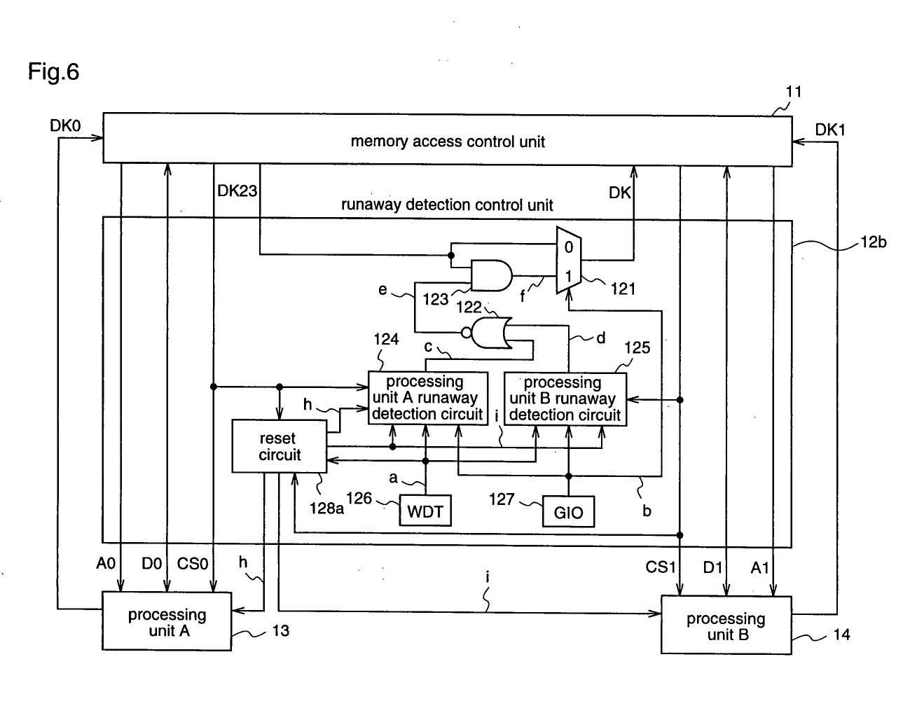

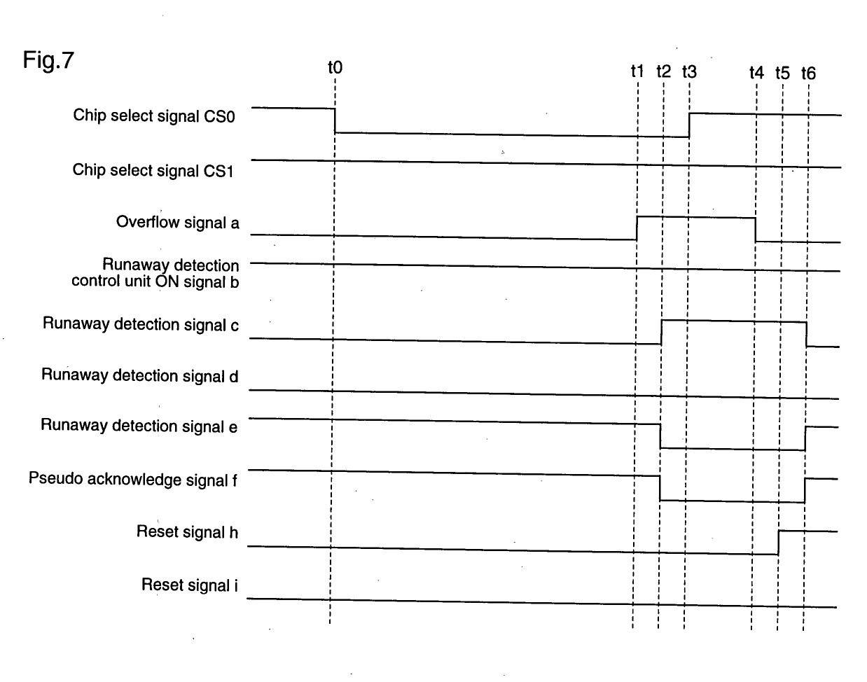

A microcomputer according to a third embodiment of the present invention will be described with reference to FIGS. 6 and 7.

FIG. 6 is a diagram illustrating a structure of a runaway detection control unit 12b of a microcomputer 1 according to the third embodiment. In FIG. 6, the same reference numerals as those in FIGS. 1, 2 and 13 denote the same or corresponding components. The runaway detection control unit 12b is characterized by a reset circuit 128a. The reset circuit 128a outputs a reset signal h to the processing unit A13 and the processing unit A runaway detection circuit 124 to fee the memory space of the processing unit A13 and to initialize the processing unit A runaway detection circuit 124. Further, the reset circuit 128a outputs a reset signal i to the processing unit B14 and the processing unit B runaway detection circuit 125 to free the memory space of the processing unit B14 and to initialize the processing unit B runaway detection circuit 125.

FIG. 7 is a timing chart for explaining an operation of the microcomputer according to the third embodiment. This figure shows a case where the CPU 10 performs a memory access to the processing unit A13. In FIG. 7, t4 shows a time when the WDT 126 negates the overflow signal a, t5 shows a time when the reset signal h from the reset circuit 128a to the processing unit A13 and the processing unit A runaway detection circuit 124 is asserted, and t6 shows a time when the memory space of the processing unit A13 is freed and the processing unit A runaway detection circuit 124 is initialized.

The operation of the runaway detection control circuit 12b of the microcomputer 1 that is constructed as described above will be described. Here, the description is given assuming that the runaway detection control unit 12b is in ON state in accordance with the output signal b from the GIO 127.

Initially, an operation when the CPU 10 performs a memory access to the processing unit A13 is described. The processes from time t0 to time t3 are the same as those in the first embodiment.

After asserting the overflow signal a, the WDT 126 negates the overflow signal a at time t4 when the count value of the internal counter has reached a set value. When the overflow signal a is negated, the reset circuit 128a asserts a reset signal h in the next cycle t5, and outputs the asserted reset signal to the processing unit A13 and the processing unit A runaway detection circuit 124. Thereby, the memory space of the processing unit A13 is freed in the next cycle t6, thereby initializing the processing unit A runaway detection circuit 124.

In the case where the CPU 10 performs a memory access to the processing unit B14, when the processing unit B runaway detection circuit 125 detects a runaway of the communication between the CUP 10 and the processing unit B14, the WDT 126 negates the overflow signal a at time t4, and the reset circuit 128a asserts the reset signal i at time t5 and outputs the asserted signal to the processing unit B14 and the processing unit B runaway detection circuit 125. Thereby, at time t6, the memory space of the processing unit B14 is freed, and the processing unit B runaway detection circuit 125 is initialized.

As described above, according to the microcomputer of the third embodiment, when a communication between the CPU 10 and the external processing unit (the processing unit A13 or B14) gets into a runaway state, the memory access control unit 11 outputs a pseudo acknowledge signal f to the CPU 10, thereby finishing the memory access. When the count value of the internal counter of the WDT 126 reaches the set value after the memory access has been finished, the reset circuit 128a outputs a reset signal to the external processing unit, the communication of which with the CPU 10 has gotten into a runaway state, and the runaway detection circuit that has detected this runaway state, thereby freeing the memory space of the external processing unit and initializing the runaway detection circuit. Accordingly, even when the communication between the CPU 10 and the external processing unit gets into a runaway state, it is possible to forcefully finish this memory access to prevent the CPU 10 from getting into a runaway state and avoiding stopping the system. In addition, it is possible to initialize the runaway detection circuit that has detected the runaway in accordance with the reset signal h or i, and further free the memory space of the processing unit that has gotten into the runaway state, thereby making a standby status for the next memory access.

[Embodiment 4]

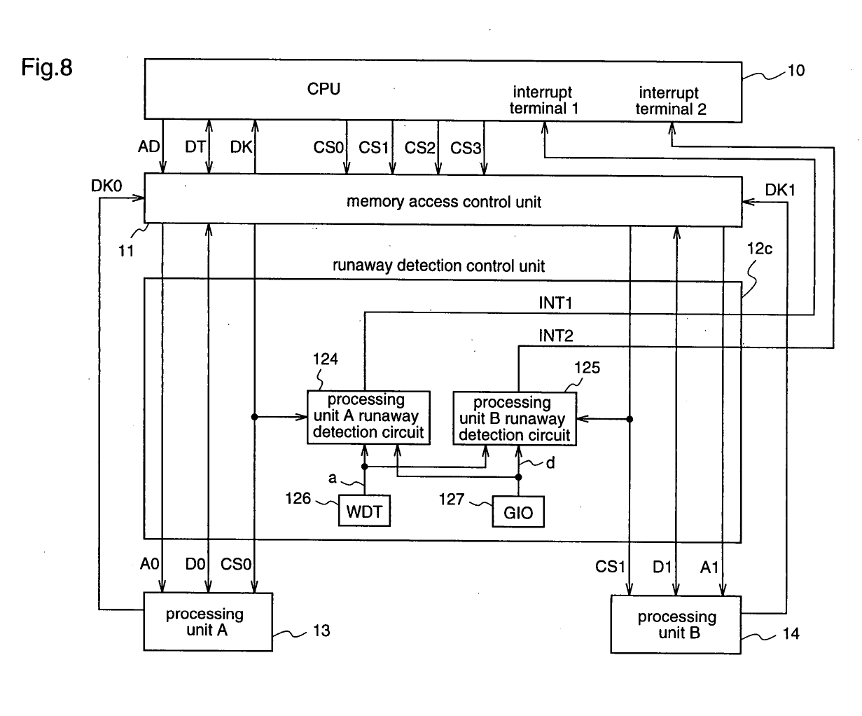

A microcomputer according to a fourth embodiment of the present invention will be described with reference to FIG. 8.

FIG. 8 is a diagram illustrating a structure of a runaway detection control unit 12c of the microcomputer according to the fourth embodiment. In FIG. 8, the same reference numerals as those in FIGS. 1, 2, and 13 denotes the same or corresponding components. The microcomputer 1 according to the fourth embodiment is characterized by that the CPU 10 and a runaway detection control unit 12c are connected through a processing unit A runaway detection signal INT1 and a processing unit B runaway detection signal INT2.

The operation of the microcomputer 1 that is constructed as described above will be described.

Initially, the description is given of the operation in a case where the CPU 10 performs a memory access to the processing unit A13. The CPU 10 outputs a chip select signal CS0 for the processing unit A and an address signal AD indicating an address value to be accessed, to the memory access control unit 11, thereby requesting the access to the processing unit A13. When receiving the chip select signal CS0 for the processing unit A and the address signal AD, the memory access control unit 11 outputs the chip select signal CS0 for the processing unit A and an address signal A0 for the processing unit A to the processing unit A13. At this time, the memory access to the processing unit A13 is started.

When receiving an asserted overflow signal a from the WDT 126 before the memory access from the CPU 10 to the processing unit A13 is finished, the processing unit A runaway detection circuit 124 directly outputs a processing unit A runaway detection signal INT1 to an interrupt terminal 1 of an interrupt processing unit of the CPU 10 in the next cycle. When receiving the processing unit A runaway detection signal INT1, the interrupt processing unit limits the memory access to the processing unit A13.

Similarly, in the case of a memory access from the CPU 10 to the processing unit B14, when detecting a runaway state of a communication between the CPU 10 and the processing unit B14, the processing unit B runaway detection circuit 125 directly outputs a processing unit B runaway detection signal INT2 to an interrupt terminal 2 of the interrupt processing unit of the CPU 10.

When receiving the processing unit A runaway detection signal INT1, the CPU 10 switches the memory access method for the processing unit A13 from the handshaking mode to the fixed waiting mode, and when receiving the processing unit B runaway detection signal INT2, the CPU 10 switches the memory access method for the processing unit B14 from the handshaking mode to the fixed waiting mode. Thereby, even when the communication between the CPU 10 and the processing unit A13 or B14 gets into a runaway state, it is possible to prevent the CPU 10 from getting into a runaway state.

As described above, according to the microcomputer of the fourth embodiment, when the runaway detection circuit (the processing unit A runaway detection circuit 124 or the processing unit B runaway detection circuit 125) detects a runaway of a communication between the CPU 10 and an external processing unit (the processing unit A13 or B14) in the case where the CPU 10 performs an access to the external processing unit in the handshaking method, a runaway detection signal (the processing unit A runaway detection signal INT1 or the processing unit B runaway detection signal INT2) is directly inputted from the runaway detection circuit to the interrupt terminal (the interrupt terminal 1 or 2) of the interrupt processing unit of the CPU 10. Then, the CPU 10 switches the memory access method for the external processing unit from the handshaking mode to the fixed waiting mode in accordance with the runaway detection signal. Thereby, even when the communication between the CPU 10 and the external processing unit gets into a runaway state, it is possible to finish the memory access to promptly avoid a runaway state of the CPU 10 and a stop of the system, thereby realizing an early return of the CPU from the runaway state.

[Embodiment 5]

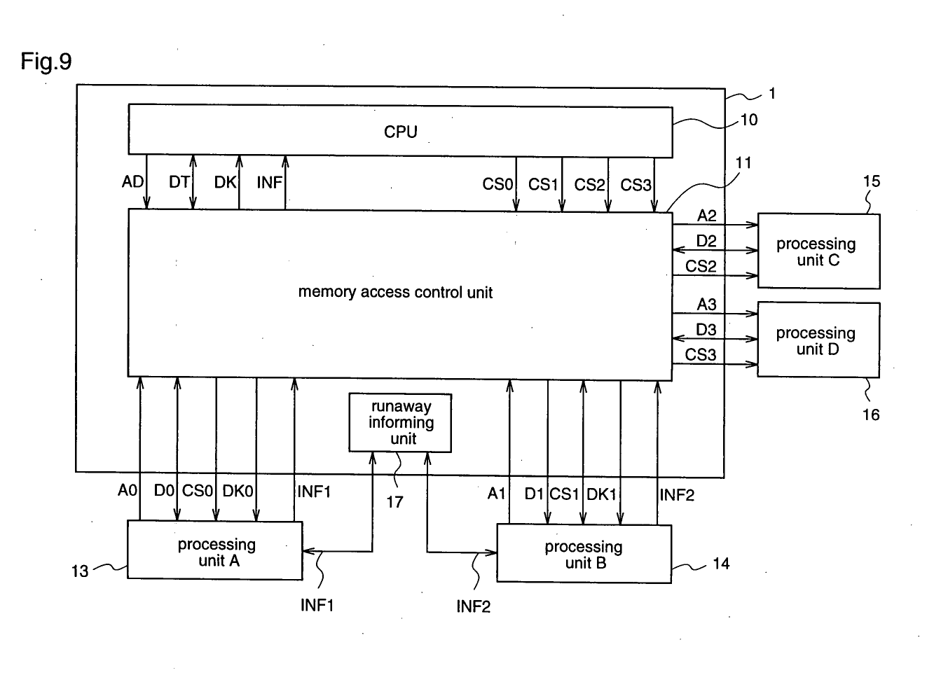

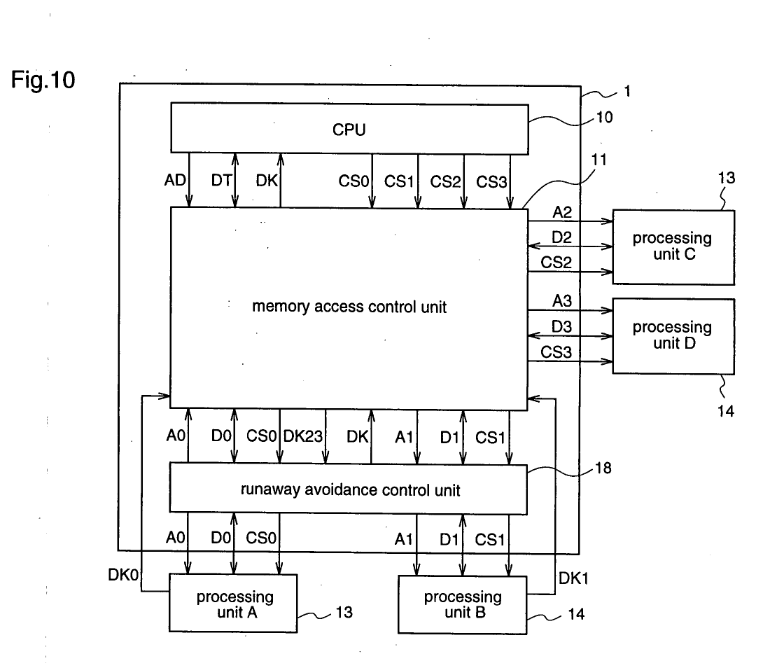

A microcomputer according to a fifth embodiment of the present invention will be described with reference to FIGS. 9 and 10.

FIG. 9 is a block diagram illustrating a structure of the microcomputer according to the fifth embodiment. In FIG. 9, the same reference numerals as those in FIG. 13 denote the same or corresponding components. The microcomputer 1 according to the fifth embodiment is characterized by a runaway informing unit 17. In FIG. 9, when the processing unit A13 gets out of control, the runaway informing unit 17 receives a runaway information signal INF1 from the processing unit A13. For example, the processing unit A13 having an internal counter outputs a runaway information signal INF1 to the runaway informing unit 17 when the memory access is not finished after a time period that is sufficiently longer that the normal memory access time has elapsed. When receiving the runaway information signal INF1 from the processing unit A13, the runaway informing unit 17 informs to the CPU 10 that the processing unit A13 has caused a runaway via the processing unit B14 and the memory access control unit 11. Further, when the processing unit B14 has caused a runaway, the runaway informing unit 17 receives a runaway information signal INF2 from the processing unit B14, and informs to the CPU 10 that the processing unit B14 has caused a runaway via the processing unit A13 and the memory access control unit 11.

The operation of the microcomputer 1 that is constructed as described above will be described. Initially, the description is given of an operation when the CPU 10 performs a memory access to the processing unit A13. When performing a memory access to the processing unit A13, the CPU 10 outputs a chip select signal CS0 for the processing unit A and an address signal AD indicating an address value that is to be accessed, to the memory access control unit 11, thereby requesting the access to the processing unit A13. When receiving these signals, the memory access control unit 11 outputs the chip select signal CS0 for the processing unit A and an address signal A0 for the processing unit A to the processing unit A13. At this point of time, the memory access to the processing unit A13 is started.

When the memory access does not end even when the normal memory access time has elapsed after the memory access from the CPU 10 to the processing unit A13 has been started, the runaway informing unit 17 receives the runaway information signal INF1 from the processing unit A. When receiving the runaway information signal INF1, the runaway informing unit 17 informs to the CPU 10 that the processing unit A13 is in a runaway state, via the other processing unit B14 that is performing the normal operation and the memory access control unit 11. That is, the runaway informing unit 17 outputs the runaway information signal INF2 to the processing unit B14, and then this runaway information signal INF2 is inputted to the CPU 10 via the processing unit B14 and the memory access control unit 11. In this way, the runaway informing unit 17 requests the limitation of the memory access. The CPU 10 that is informed that the processing unit A13 is in a runaway state stops the memory access to the processing unit A13 that is in a runaway state, thereby returning the system from the runaway state.

Further, when the communication between the CPU 10 and the processing unit B14 causes a runaway, the runaway informing unit 17 receives a runaway information signal INF2 from the processing unit B14, and informs to the CPU 10 that the processing unit B14 is in a runaway state via the processing unit A13 and the memory access control unit 11. That is, the runaway informing unit 17 outputs the runaway information signal INF1 to the processing unit A13, and this runaway information signal INF1 is inputted to the CPU 10 via the processing unit A13 and the memory access control unit 11.

As described above, the microcomputer according to the fifth embodiment includes the runaway informing unit 17, and when an external processing unit (for example, the processing unit A13) causes a runaway, the runaway informing unit 17 informs to the CPU 10 that the processing unit is in a runaway state, via a different external processing unit (for example, the processing unit B14) and the memory access control unit 11. Thereby, even when the communication between the CPU 10 and the external processing unit (the processing unit A13 or B14) gets into a runaway state, it is possible to prevent the CPU 10 from getting into a runaway state, thereby avoiding a stop of the system.

[Embodiment 6]

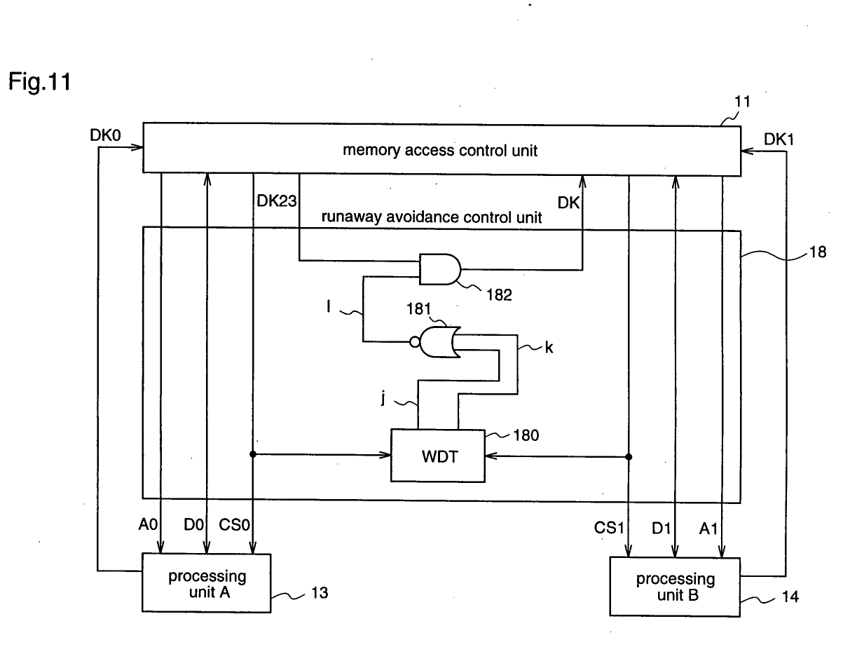

A microcomputer according to a sixth embodiment of the present invention will be described with reference to FIGS. 10 and 11.

FIG. 10 is a block diagram illustrating a microcomputer according to the sixth embodiment. The same reference numerals as those in FIG. 13 denote the same or corresponding components. The microcomputer according to the sixth embodiment is characterized by a runaway avoidance control unit 18. The runaway avoidance control unit 18 monitors a runaway state of a communication between the CPU 10 and the processing unit A13 or B14 via the memory access control unit 11, thereby avoiding the runaway.

FIG. 11 is a diagram illustrating a detailed structure of the runaway avoidance control unit 18. In FIG. 11, the runaway avoidance control unit 18 includes a WDT 180, a NOR circuit 181, and an AND circuit 182. The WDT 180 generates a pulse signal when the count value of the internal counter has reached a set value. When the CPU 10 performs a memory access to the processing unit A13, the WDT 180 generates a pulse signal j for the processing unit A, and when the CPU 10 performs a memory access to the processing unit B14, the WDT generates a pulse signal k for the processing unit B. The NOR circuit 181 receives the pulse signal j for the processing unit A or the pulse signal k for the processing unit B, and outputs a pseudo acknowledge signal 1. The AND circuit 182 receives the pseudo acknowledge signal 1 and a normal acknowledge signal DK 23, and generates an acknowledge signal DK to be outputted to the CPU 10.

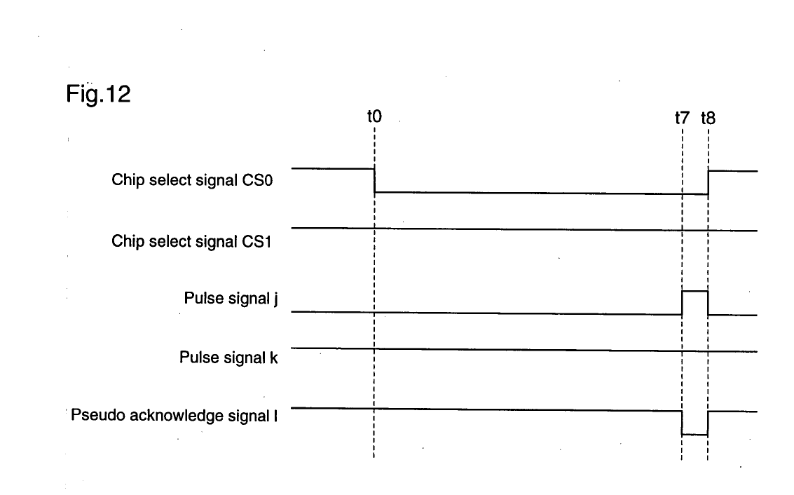

The operation of the microcomputer according to the sixth embodiment that is constructed as described above will be described with reference to FIG. 12. FIG. 12 is a timing chart for explaining the operation of the microcomputer according to the sixth embodiment. This figure shows a memory access from the CPU 10 to the processing unit A13. In FIG. 12, t0 shows a time when the a chip select signal CS0 for the processing unit A is asserted, t7 shows a time when the WDT 180 generates a pulse signal and a pseudo acknowledge signal 1 is asserted, and t8 shows a time when the memory access from the CPU 10 to the processing unit A13 is finished.

When performing a memory access to the processing unit A13, the CPU 10 outputs a chip select signal CS0 for the processing unit A and an address signal AD indicating an address value to be accessed, to the memory access control unit 11 at time t0, thereby requesting the memory access to the processing unit A13. When receiving these signals, the memory access control unit 11 outputs the chip select signal CS0 for the processing unit A and an address signal A0 for the processing unit A to the processing unit A13.

At this point of time, the memory access to the processing unit A13 is started. Then, the WDT 180 counts up the time from when the chip select signal CS0 for the processing unit A has been asserted by an internal asynchronous counter and, when the count value exceeds a set value, generates a pulse signal j for the processing unit A at timing t7. The NOR circuit 181 generates a pseudo acknowledge signal 1 at timing t7, and the AND circuit 182 outputs the pseudo acknowledge signal 1 to the CPU 10 as an acknowledge signal DK, thereby forcefully finishing the memory access at timing t8.

Similarly, when the CPU 10 performs a memory access to the processing unit B14, the WDT 180 counts up the time from when a chip select signal CS1 for the processing unit B has been asserted by the internal asynchronous counter and, when the count value exceeds a set value, generates a pulse signal k for the processing unit B at timing t7. The NOR circuit 181 generates a pseudo acknowledge signal 1, and the AND circuit 182 outputs the pseudo acknowledge signal 1 to the CPU 10 as the acknowledge signal DK, thereby forcefully finishing the memory access at timing t8.

As described above, the microcomputer according to the sixth embodiment includes the runaway avoidance control unit 18 that connects the memory access control unit 11 and the external processing units (the processing units A13 and B14). When a predetermined time period has elapsed from when the memory access was started, the runaway avoidance control unit 18 generates a pseudo acknowledge signal 1, which is inputted to the CPU 10 as an acknowledge signal DK via the memory access control unit 11. Then, the CPU 10 recognizes that the memory access is completed in accordance with the pseudo acknowledge signal DK, thereby finishing the memory access. Thereby, it is possible to forcefully finish the memory access between the CPU 10 and the external processing unit after the predetermined time period has elapsed from the start of the memory access, thereby avoiding a runaway of the system.

This invention is suitable for a system that performs a memory access with a large amount of processing from a microcomputer to an external memory.

What is claimed is:

1. A microcomputer comprising a central processing unit and a memory access control unit that performs a control when the central processing unit makes a memory access to an external processing unit having a memory function, including
a runaway detection control unit comprising:
a watching dog timer including a counter, for counting a time using the counter and generating a pulse signal when a predetermined time is counted;
a runaway detection circuit for detecting that a memory access from the central processing unit to the external processing unit has not been normally finished and outputting a runaway detection signal;
a signal generation unit for generating a pseudo acknowledge signal indicating that the memory access from the central processing unit to the external processing unit has been finished, on the basis of the runaway detection signal, and outputting the generated acknowledge signal to the central processing unit; and
said runaway detection circuit outputting the runaway detection signal when the watching dog timer generates the pulse signal during a period from which a memory access from the central processing unit to the external processing unit is started to when the memory access is finished.

2. The microcomputer of claim 1 wherein
said central processing unit exclusively performs a memory access to a plurality of the external processing units, and
said runaway detection control unit detects an external processing unit, the memory access to which from the central processing unit has not been normally finished.

3. The microcomputer of claim 1 wherein
when the runaway detection control unit detects that the memory access from the central processing unit to the external processing unit has not been normally finished, the central processing unit switches a memory access method for the external processing unit from a handshaking mode to a fixed waiting mode.

4. The microcomputer of claim 2 wherein
said runaway detection control unit includes a reset circuit for initializing the runaway detection circuit which has detected that the memory access from the central processing unit to the external processing unit has not been normally finished, and freeing a memory space of the external processing unit, the memory access to which from the central processing unit has not been normally finished.

5. A microcomputer comprising a central processing unit and a memory access control unit that performs a control when the central processing unit makes a memory access to an external processing unit having a memory function, including
a runaway detection control unit comprising:
a watching dog timer including a counter, for counting a time using the counter and generating a pulse signal when a predetermined time is counted;
a runaway detection circuit for detecting that a memory access from the central processing unit to the external processing unit has not been normally finished and outputting a runaway detection signal; and
said runaway detection circuit outputting the runaway detection signal to an interrupt processing unit of the central processing unit when the watching dog timer generates the pulse signal during a period from when the memory access from the central processing unit to the external processing unit is started to which the memory access is finished, and
said interrupt processing unit limiting the memory access to the external processing unit when receiving the runaway detection signal.

6. A microcomputer comprising a central processing unit and a memory access control unit that performs a control when the central processing unit exclusively makes a memory access to a plurality of external processing units each having a memory function, including:
a runaway informing unit for receiving a runaway notification from an external processing unit, the memory access to which from the central processing unit has not been normally finish and has gotten into a runaway state, and providing the central processing unit with information of the external processing unit that has gotten into the runaway state via an external processing unit that is different from the external processing unit that has gotten into the runaway state and the memory access control unit.

7. A microcomputer comprising a central processing unit and a memory access control unit that performs a control when the central processing unit makes a memory access to an external processing unit having a memory function, including
a runaway avoidance control unit comprising:
a watching dog timer including a counter, for counting a time using the counter and generating a pulse signal when a predetermined time is counted;
a signal generation unit for generating a pseudo acknowledge signal indicating that a memory access from the central processing unit to the external processing unit has been finished, on the basis of the pulse signal; and
said signal generation unit outputting the pseudo acknowledge signal to the central processing unit when the watching dog timer has counted the predetermined time after the memory access was started.
